(19) United States
(12) Patent Application Publication
(10) Pub. No.: US 2017/0355820 A1
(43) Pub. Date: Dec. 14, 2017

(54) AROMATIC POLYIMIDES SUITABLE FOR AEROSPACE PARTS VIA 3D PRINTING PROCESSES

(71) Applicant: PolyOne Corporation, Avon Lake, OH (US)

(72) Inventors: Ling HU, Westlake, OH (US); Roger W. AVAKIAN, Solon, OH (US)

(21) Appl. No.: 15/618,709

(22) Filed: Jun. 9, 2017

Related U.S. Application Data
(60) Provisional application No. 62/348,453, filed on Jun. 10, 2016.

(51) Int. Cl. C08G 73/10; C08K 7/02; B33Y 70/00; B29K 105/00; B64C 1/00; B29K 79/00

(52) U.S. Cl. CPC C08G 73/1071; C08K 7/02; B33Y 70/00; B64C 1/00; B64C 2001/0072; B29K 2079/08; B29K 2105/251

(57) ABSTRACT

Novel aromatic polyimides, both thermoplastic and thermosettable, are disclosed based on use of asymmetric diamines and symmetric dianhydrides with either a functional endcap for further thermosetting or a non-functional endcap for retention of thermoplastic properties. Both aromatic polyimides have sufficient physical properties to be useful in 3D printing.

### CLAIM OF PRIORITY

This application claims priority from U.S. Provisional Patent Application Ser. No. 62/348,453 bearing Attorney Docket Number 12016021 and filed on Jun. 10, 2016, which is incorporated by reference.

### GOVERNMENT LICENSE RIGHTS

This invention was made with government support under Contract No. P1401943 (RSC13006) awarded by the United States Air Force. The government has certain rights in the invention.

### FIELD OF THE INVENTION

This invention concerns the production of new aromatic polyimides suitable for use in the manufacture of aerospace parts using thermoplastic polymer articles via 3D printing, also known as “additive manufacturing” or “fused deposition modeling”.

### BACKGROUND OF THE INVENTION

High performance imide polymers are characterized by excellent thermal stability, solvent resistance and high glass transition temperatures (Tg). U.S. Pat. No. 7,015,304 and RE43,880 (both Chuang), the disclosures of which are incorporated by reference, disclose the preparation by a batch process of solvent-free, low-melt imide oligomers and thermosetting polyimides, and to the process of preparing such oligomers and polyimides.

U.S. Pat. No. 6,066,710 (Becker et al.) discloses an extrusion process for making aromatic polyimides from symmetrical dianhydrides.

Also U.S. Pat. No. 8,093,348 (Chuang), the disclosure of which is incorporated by reference, discloses a variety of starting asymmetric dianhydride monomers, diamine monomers, and endcap monomers useful for making aromatic polyimide polymers.

PCT Patent Application Publication No. WO 2015/048,071 (Hu and Avakian) discloses four new thermoplastic aromatic polyimides suitable for 3D printing. None of them uses a symmetrical dianhydride.

None of these prior efforts has addressed the particular and peculiar requirements for polymerizing monomers to yield thermosettable aromatic polyimides which are processed like thermoplastic prior to being cured to form thermoset polyimides and also are suitable for aerospace parts using 3D printing.

3D printing (also known by the other phrases identified above) is being hailed in the polymer industry as a new means of forming shaped polymeric articles, literally from the ground up. Like soldering, a space is filled by a material coming from a filamentary form and being heated for delivery precisely to the x-y-z coordinates of that space. A lattice or scaffold of supporting material is also often delivered to adjoining spaces in the same precise manner to fortify the polymeric material of the shaped, printed article until that polymeric material sufficiently cools to provide a final rigid structure in the desired shape, which can be separated from the supporting material.

The polymeric material considered for use in 3D printing has included customary amorphous thermoplastic polymers but has recently also focused on thermoplastic resins and blends of polymer resins which have high temperature performance properties. Both thermoplastic and thermoset aromatic polyimides have been considered candidates for use in 3D printing.

### SUMMARY OF THE INVENTION

What the art needs is a thermosettable aromatic polyimide having a Tg greater than about 170° C. after curing which has high enough molecular weight to be sufficiently ductile that it can be formed into a filament or self-supporting spaghetti form having a diameter ranging from about 1.6 to about 2.1 mm and preferably from about 1.74 to about 1.86 mm for spooling or other delivery mechanism to a 3D printer.

Thus, aromatic polyimides having high Tg values in excess of 220° C. and preferably in excess of 270° C. after curing can be included in the cadre of resins available for the emerging industry of 3D printing of articles using polymers.

The present invention has made 3D printing for high Tg resins possible by synthesizing new thermosettable aromatic polyimides which are both strong enough to be made into a 3D printing filament or self-supporting spaghetti of the diameter described above and also ductile enough to be useful as a filament for delivery to a 3D printing head.

None of the prior art identified above arose in the time when the particularities of 3D printing were truly understood, particularly for high temperature polymers which have melting temperatures hotter than a pizza oven.

The present invention utilizes a particular combination of monomers: (a) a symmetric dianhydride in reaction with (b) an asymmetric aromatic diamines while being subjected to a competing reaction with (c) either a mono-anhydride capable of capping the end(s) of the growing polyimide polymer chains but having retained functionality for crosslinking of the polyimide or other subsequent reaction or an endcapping mono-anhydride without retained functionality.

Unfortunately, preparation of high performance imide polymers involve difficult reactions and can benefit from reactive extrusion, a continuous process with timed introduction of the ingredients to form the imide oligomer taught in U.S. Pat. Nos. 7,015,304 and RE43,880 (both Chuang).

But neither Chuang (who utilized asymmetric dianhydrides and asymmetric diamines) nor Becker et al. (who utilized symmetric dianhydrides and symmetric diamines) recognized the particular properties necessary for making the high Tg polymer into filaments to be deliverable in ductile form for 3D printing. Hence, this invention involves synthesis of new polymers.

One aspect of the invention is a new aromatic polyimide comprising:

Thermosettable Poly (2-(4-{3-[1,3-dioxo-5-(2-phenylethynyl)-2,3-dihydro-1H-isoindol-2-yl]phenoxy}phenyl)-5-{[2-(3-{4-[1,3-dioxo-5-(2-phenylethynyl)-2,3-dihydro-1H-isoindol-2-yl]phenoxy}phenyl)-1,3-dioxo-2,3-dihydro-1H-isoindol-5-yl]oxy}-2,3-dihydro-1H-isoindole-1,3-dione))

or

Thermoplastic Poly (2-{4-[3-(1,3-dioxo-2,3-dihydro-1H-isoindol-2-yl)phenoxy]phenyl}-5-[(2-{3-[4-(1,3-dioxo-2,3-dihydro-1H-isoindol-2-yl)phenoxy]phenyl}-1,3-dioxo-2,3-dihydro-1H-isoindol-5-yl)oxy]-2,3-dihydro-1H-isoindole-1,3-dione))

Another aspect of the present invention is an aromatic polyimide comprising the reaction product of (1) 3, 4′-oxydianiline (3,4′ ODA); (2) 4, 4′-Oxydiphthalic anhydride (ODPA); and (3) a crosslinking agent selected from the group consisting of 4-phenylethynyl phthalic anhydride (4-PEPA) and phthalic anhydride (PA); wherein the 3, 4′ ODA, the ODPA, and the crosslinking agent are in a molar ratio of about 1:0.80:0.4 to about 1:0.98:0.03, respectively.

Embodiments of the invention are explained with reference to the drawing.

### BRIEF DESCRIPTION OF THE DRAWING

FIG. 1 is a schematic view of the reactive extrusion process of the invention.

### EMBODIMENTS OF THE INVENTION

Ingredients for Preparing the High Temperature Polyamides

Table 1 shows the ingredients used to prepare the novel polyimides. The amount of endcap determines the molecular weight of the resulting aromatic polyimide because the endcap competes with the symmetric dianhydride for reaction sites at the asymmetric diamine(s). It has been found that to synthesize filament-quality polyimide, the amount of endcap such as 4-phenylethynyl phthalic anhydride or phthalic anhydride should be less than about 0.4 mole percent of reactant.

The choice of endcap can be based on the desire to produce either a thermoplastic aromatic polyimide of 3, 4′ ODA and ODPA or a thermosettable aromatic polyimide of the same asymmetric diamine and symmetric dianhydride. For the former, a non-functional mono-anhydride such as phthalic anhydride can be used, in which the anhydride opens for endcapping but has no further functionality for crosslinking or other later reaction. For the latter, 4-phenylethynyl phthalic anhydride can be used, whereby the anhydride opens for endcapping but the phenylethynyl moiety remains functional for crosslinking or other later reaction.

TABLE 1

| | | |
|---|---|---|
| Brand Name | Ingredient | Formula |

Asymmetric Diamine

| | | |
|---|---|---|
| 3,4′ ODA | 3,4′-oxydianiline, CAS No. 2657-87-6; Mw = 200.24, Tm = 74~75° C., | 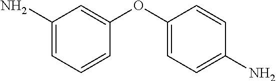 [SMILES: Nc1ccc(Oc2cccc(N)c2)cc1] |

Symmetric Dianhydride

| | | |
|---|---|---|
| 4,4′ODPA | 4,4′-oxydiphthalic anhydride, CAS#: 1823-59-2; Mw = 310.21, Tm = 225~229° C. | 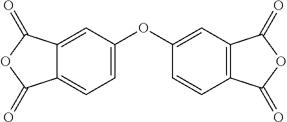 [SMILES: O=C1OC(=O)c2cc(Oc3ccc4c(c3)C(=O)OC4=O)ccc21] |

Endcaps

| | | |
|---|---|---|
| 4-PEPA | 4-phenylethynylphthalic anhydride, CAS No. 119389-05-8, Mw = 248.24, Tm = 152.0° C. | 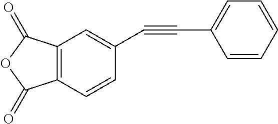 [SMILES: O=C1OC(=O)c2cc(C#Cc3ccccc3)ccc21] |
| PA | Phthalic anhydride, MW = 148.12 (Tm = 131~134° C., and Tb = 284° C.) (CAS:85-44-9) | 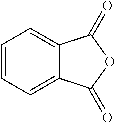 [SMILES: O=C1OC(=O)c2ccccc21] |

The use of a symmetrical dianhydride with an asymmetrical diamine is novel to the collection of known aromatic polyimides. The choice of endcap is made based on the desire for a thermoplastic aromatic polyimide or a thermosettable aromatic polyimide in which the endcap remains functional at the phenylethynyl moiety for cross-linking to form a thermoset aromatic polyimide or to form another reaction.

As explained in PCT Patent Application Publication No. WO 2015/048,071, it was described that the use of a symmetrical diamine: 1,3,-Bis(3-aminophenoxy)benzene (1,3,3′ APB) failed while the use of a very related symmetrical diamine: 1,3-Bis(4-aminophenoxy)benzene (1,3,4′ APB) succeeded in the synthesis of those aromatic polyimides from an asymmetric dianhydride and a combination of asymmetric and symmetric diamines. In other words, with all other factors constant, the difference in performance between 1,3,3′ APB and 1,3,4′ APB used in combination with an asymmetric diamine was unexplainable.

For this reason, it is not presently possible for one having ordinary skill in the art to predict which combination of symmetric dianhydride, asymmetric diamine(s), and endcaps will result in a new polyimide resin with sufficient ductile and flexible strength to be formed into a filament and wound upon a spool of conventional size for use in 3D printing.

Concurrent or Sequential Reactive Extrusion

One method of reaction is the contact of the endcap with the diamine concurrent with the contact of the dianhydride with the diamine, in order to establish a competition for diamine reaction sites as soon as melting has commenced in the upstream zones of an extruder. The melt-mixing of the dianhydride and the diamine can result in suitable reaction, even while the endcap is also competing for reaction with the diamine(s) in the extruder.

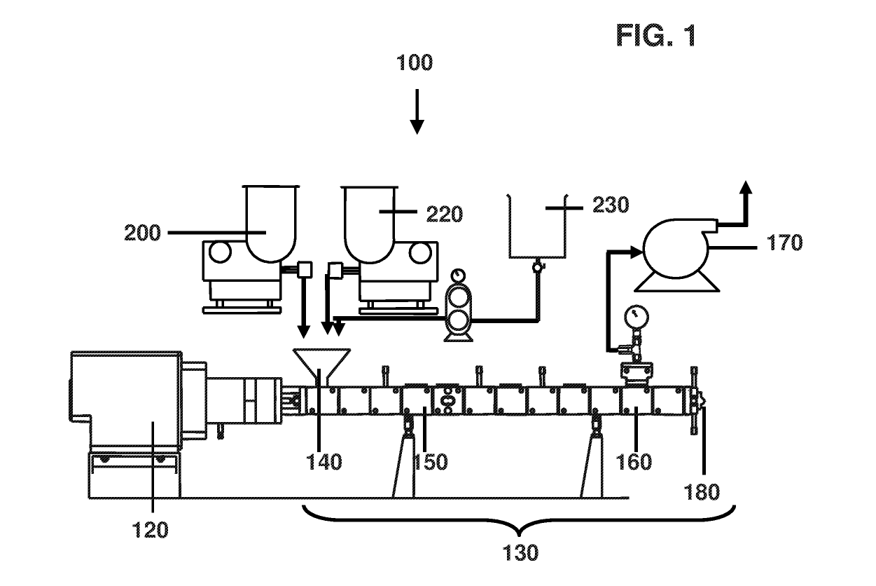

FIG. 1 provides a schematic view of the reactive extrusion method useful for the polyimide.

Alternatively, as explained in PCT Patent Publication WO 2013/006621 (Golba et al.), a second method of reaction can be the delayed addition of endcap in a later zone, such as the fourth zone, allowing the dianhydride and the diamine(s) to melt and commence reaction before introduction of the endcap commences competition for the diamine reaction sites.

The process can be based on the use of an extruder 100 having a source of power 120 and a series of heated zones 130 through which ingredients travel in a molten state. The extruder can be a twin screw extruder, either co-rotating or counter-rotating and have a screw diameter ranging from 16 mm to 45 mm.

The series of heated zones 130 can number more than six and usually eight or nine, allowing the establishment of different temperatures associated with different segments of screws (not shown) propelling the molten ingredients through the extruder and encountering other ingredients in conditions ripe for planned reaction. FIG. 1 shows twelve zones 130 for extruder 100.

Among the series of zones is a first unheated or cooled zone or throat 140 of the extruder, into which all of the ingredients are added. In the alternative approach, sequential reactive extrusion, a subsequent or downstream zone 150 contains a port for injection of at least one other ingredient. After the last ingredient(s) is(are) added at zone 150, regardless of concurrent or sequential technique, further melt-mixing and planned reaction occur, until an evacuation zone 160 is reached further downstream. Zone 160 can be connected to a source of vacuum power 170 to vent any volatiles, such as water or steam. The melted, mixed, and reacted product of the extruder 100 is extruded through a die 180, for further processing such as pelletizing for later melt-mixing or reaction.

Alternatively, directly for 3D printing, the die 180 can be of a diameter to yield filaments of a diameter of from about 1.6 to about 2.1 mm and preferably from about 1.7 mm to about 1.9 mm, and the extrudate can be wound directly upon the spool for later use in the 3D printing in any shape conceivable in three dimensional space.

In the present invention, the reactive extruder 100 can be configured to have a first feeder 200, a second feeder 220, and a third feeder 230 to introduce the dianhydride, the diamine, and the endcap, respectively, into the throat 140, commencing the journey through the extruder in which the early or upstream zones are heated to melt all three or more ingredients and to facilitate a reaction among them.

At the throat, shown as 140 in FIG. 1, the endcap can be introduced via third feeder 230 even before the dianhydride and the diamine to have begun reacting. The endcap can be a solid or a liquid, preferably, the latter to assist in the competition of reacting with the diamine while the dianhydride also is reacting with the diamine. In the alternative, sequential technique, the feeder 230 delivers the endcap at a downstream zone 150.

The reaction temperature, as reported by Chuang for a batch process, can range from about 232° to about 280° C.

However, in this invention, it has been found that each of the zones of the reactive extruder should be heated to a temperature within the range of 320° C. to 400° C. Conventionally, the temperature remains the same or increases for the sequential zones, until the die zone 180, at which the same or slightly lower or higher temperature prepares the extrudate for exit from the extruder and cooling into strands, pellets, etc.

Those persons having ordinary skill in the art of reactive extrusion, without undue experimentation, can select the appropriate temperatures for the zones within the 320° C. to 400° C. range identified above, as a result of review of the Examples below. Also, those same persons, without undue experimentation, can establish screw rotation revolutions per minute to establish the time of transit through each zone of the extruder 100, which can be a factor in the kinetics of the reactive extrusion planned for the dianhydride and diamine in the concurrent or sequential presence of the mono-anhydride endcap, with or without phenylethynyl functionality to determine thermoplastic or thermosettable performance properties.

Usefulness of the Invention

The thermoplastic aromatic polyimide formed by the concurrent reactive extrusion process of this invention using PA can be blend by melt-mixing with a variety of other ingredients.

The thermosettable aromatic polyimide formed by the concurrent reactive extrusion process of this invention using 4-PEPA can be further reacted or crosslinked at temperatures ranging from about 340° to 360° C. to obtain a thermosetting polyimide matrix having a Tg ranging from about 300°-370° C.

In one usage, either of the specific polyimides synthesized according to this invention are engineered for use in the 3D printing technique of plastic article shaping. Simple or complex shapes can be printed digitally relying upon the x-y-z coordinates of space and computer software to drive the printer using filaments of the polyimides of this invention to melt, deposit, and cool layer-by-layer in the z axis above the x-y plane to build any conceivable three-dimensional polyimide object.

Combining the emerging technique of 3D printing with the high temperature performance of polyimide is a tremendous combination of manufacturing processing and end-use performance not previously achieved. 3D printed polymer articles can be of any form or shape conceivable, even a Möbius strip.

Composites of either of the aromatic polyimides of this invention with other ingredients added for functional purposes can be used in a number of high performance articles, such as lightweight polymer composites (e.g., airframe and engine components); military and commercial aircraft; missiles, radomes, and rockets, etc.; high temperature laminates; electrical transformers; bushings/bearings for engines; oil drilling equipment; oil drilling risers; automotive chassis bearings; and films for use in electronics, fuel cells and batteries.

The new production of composites begins with the solvent-less reactive extrusion process described above, which has resulted in polyimide in the form of dry powders, pellets, filaments, films, etc. The production utilizes powder or pellets of the polyimide to be fed as solid articles into a single screw extruder with an appropriate film or sheet extrusion die and operating at temperatures above the melting point of the polyimide. The extruder would rapidly melt the dry polymer to produce a thin film emerging from the die.

It is also possible to include carbon, glass, or synthetic fibers as additives in the reactive extrusion to form the aromatic polyimide.

It is also possible for the polyimide being reactively extruded to be extruded using a sheet or film die in the melt form directly onto fibers (woven or nonwoven) for cooling and subsequent use.

One embodiment of forming a composite from a thermosettable aromatic polyimide of the invention solves problems with the production of polyimide pre-pregs or preforms. The means of curing can be a resin-transfer molding process or selective laser sintering or other means in which the functional phenylethynyl moiety can further react.

This conventional production currently relies on the melting of solid resins in heated feed tanks, transfer of the melt to a three-roll mill type feeding system, production of a thin film on a roller, and then transfer of the film to a uni-dimensional tape or a fabric which can be made of carbon fibers, fiberglass, and polymers, such as Kevlar™ brand polymer, or combinations of them. This conventional production requires that these imide oligomeric thermoset resins be stored at elevated temperatures for long periods of time in the heated feed tanks, which can allow those resins to begin their cross-linking chemical reactions before being rolled into films for laminated composite construction.

At best, it is estimated that the current production method allows only for a short “pot life” of one to two hours for those resins in the heated tanks before they need to be discarded as no longer reliable or viable reactive polymer systems.

The new production of composites begins with the solvent-less reactive extrusion process described above, which has resulted in polyimide oligomers in the form of dry powders, pellets, filaments, films, etc. The production utilizes powder or pellets of the imide oligomer to be fed as solid articles into a single screw extruder with an appropriate film or sheet extrusion die and operating at temperatures above the melting point of the imide oligomer. The extruder would rapidly melt the dry oligomer to produce a thin film emerging from the die, which would then be fed directly into the prepreg or preform machine for impregnation into the tape or fabric, such machine as described in U.S. Pat. No. 7,297,740 (Dyksterhouse).

The use of an extruder to re-melt the powder or pellets of aromatic polyimide still having an endcap functionality dramatically reduces the time during which the aromatic polyimide is exposed to elevated temperatures. It is probable that the total time from feeding of powder or pellets into the extruder to impregnation into the uni-dimensional tape or fabric will be only a few minutes, during which time the aromatic polyimide will have a very limited chance to react inadvertently until the time is proper in the prepreg machine.

It is also possible for the aromatic polyimide to be extruded using a sheet or film die in the melt form directly onto fibers (woven or nonwoven) for cooling and subsequent curing.

Examples further explain the invention.

### Examples

Table 2 shows the acceptable, desirable, and preferable molar ratio ranges of the monomers useful for synthesizing the polyimides. The polyimide can comprise, consist essentially of, or consist of these monomers. The monomers can be introduced separately into the throat of the extruder as seen in FIG. 1 or pre-blended before addition via a single feeder.

TABLE 2

| Molar Ratios | Acceptable | Desirable | Preferable |
|---|---|---|---|
| Asymmetric Diamine | 1.0 | 1.0 | 1.0 |
| Symmetric Dianhydride | 0.80-0.98 | 0.90-0.98 | 0.95 |
| Endcap | 0.03-0.4 | 0.04-0.2 | 0.1 |

Table 3 shows the ingredients used for the Examples and the Comparative Examples. Tables 4-6 show the molar ratios of the ingredients, the extrusion reaction conditions, and the results.

For thermosettable Examples 1-5 and Comparative Examples A-C, 10 grams of each was cured at 360° C. in an ash oven for 5 hours, followed by cooling to room temperature to be ready for DSC characterization.

Differential scanning calorimetry (DSC) was utilized to determine glass transition temperature and thermal stability. Each of Examples 1-12 and Comparative Examples A-C was analyzed using a TA Instruments model DSC Q20. The samples were exposed to a heat-cool-heat cycle in the analysis. The temperature range of each segment was from 20° C. to 350° C. at heating/cooling rates of 10° C./minute. A nitrogen gas purge of 50 ml/minute was used. The glass transition temperature (Tg) of the sample was determined using the half-height from the data recorded in the second heating segment of the analysis.

TABLE 3

| | | Commercial |
|---|---|---|
| Brand Name | Ingredient and Purpose | Source |
| 3,4′ ODA | 3,4′-oxydianiline, Mw = | Miki Sanyo (USA) |
| | 200.24, Tm = 74~75° C. | Inc. |
| ODPA | 4,4′-oxydiphthalic anhydride, | Evonik Industries |
| | CAS#: 1823-59-2; Mw = | (USA) |
| | 310.21, Tm = 225~229° C. | |
| 4-PEPA | 4-phenylethynylphthalic | Nexam (USA) |
| | anhydride, CAS No.119389-05-8, | |
| | Mw = 248.24, Tm = 152.0° C. | |
| PA | Phthalic anhydride, | Sigma Aldrich |
| | MW = 148.12 (Tm = 131~134° C., | |
| | and Tb = 284° C.) (CAS: 85-44-9) | |

TABLE 4

| | Comp. A | Comp. B | Comp. C | 1 | 2 | 3 | 4 | 5 |
|---|---|---|---|---|---|---|---|---|
| Mole Ratio of 3,4′-ODA:4, | 1:0.5:1 | 1:0.6:0.8 | 1:0.7:0.6 | 1:0.8:0.4 | 1:0.85:0.3 | 1:0.9:0.2 | 1:0.925:0.15 | 1:0.95:0.1 |
| 4′-ODPA:4-PEPA | | | | | | | | |

Monomers

| | | | | | | | | |
|---|---|---|---|---|---|---|---|---|
| 3,4′-ODA | 40.00 | 41.67 | 43.48 | 45.45 | 46.51 | 47.62 | 48.19 | 48.78 |
| 4,4′ ODPA | 20.00 | 25.00 | 30.43 | 36.36 | 39.53 | 42.86 | 44.58 | 46.34 |
| 4-PEPA | 40.00 | 33.33 | 26.09 | 18.18 | 13.95 | 9.52 | 7.23 | 4.88 |

| | |
|---|---|
| Extruder | Prism 16 millimeter Twin Screw Extruder (L/D: 40) |
| Order of addition | All ingredients were mixed by blender and then added at throat |

Temperature at different Zone, ° C.

| | | | | | | | | |
|---|---|---|---|---|---|---|---|---|
| Zone 1 | n/a | n/a | n/a | n/a | 280 | 280 | 280 | 280 |
| Zone 2 | 100 | 100 | 210 | 250 | 280 | 280 | 280 | 280 |
| Zone 3 | 230 | 230 | 270 | 270 | 320 | 280 | 320 | 320 |
| Zone 4 | 230 | 230 | 270 | 270 | 320 | 280 | 320 | 320 |
| Zone 5 | 230 | 230 | 270 | 270 | 350 | 320 | 320 | 320 |
| Zone 6 | 230 | 230 | 270 | 270 | 350 | 320 | 340 | 340 |
| Zone 7 | 230 | 230 | 270 | 270 | 350 | 320 | 340 | 340 |
| Zone 8 (vacuum port) | 230 | 230 | 270 | 270 | 350 | 320 | 340 | 340 |
| Zone 9 | 230 | 230 | 270 | 270 | 350 | 320 | 340 | 340 |
| Die | 210 | 210 | 250 | 250 | 340 | 300 | 320 | 320 |
| Mole Ratio of 3,4′-ODA:4, | 1:0.5:1 | 1:0.6:0.8 | 1:0.7:0.6 | 1:0.8:0.4 | 1:0.85:0.3 | 1:0.9:0.2 | 1:0.925:0.15 | 1:0.95:0.1 |
| 4′-ODPA:4-PEPA | | | | | | | | |
| Screw RPM | 150 | 150 | 150 | 200 | 250 | 250 | 250 | 250 |
| Results | Very Low | Yellow | Yellow | Yellow | Yellow | Yellow | Clear | Clear |
| | Viscosity | Molten | Molten | Molten | Molten | Molten | Brown | Brown |
| | Yellow | Material | Material | Material | Material | Material | Molten | Molten |
| | Molten | | | | | | Material | Material |
| | Material | | | | | | | |
| Tg Of Uncured Resin | 135.5 | 143.4 | 158.1 | 171.6 | 184.6 | 207.6 | 210.9 | 212.7 |
| Measured By DSC, ° C. | | | | | | | | |
| (Room Temp To 350 C.) | | | | | | | | |
| Tg Of The Cured Resin | 301.4 | 291.1 | 280.3 | 272.6 | 262.3 | 255.9 | 252.1 | 246.6 |
| By DSC (Room Temp To | | | | | | | | |
| 400 C.) | | | | | | | | |
| Possibility To Make | No | No | No | Yes, | Yes | Yes | Yes | Yes |
| Spaghetti Form Which | | | | barely | | | | |
| Can Support By Itself | | | | | | | | |

TABLE 5

| 6 | 7 | 8 | 9 | 10 |
|---|---|---|---|---|
| Mole Ratio of 3,4′-ODA:4,4′-ODPA:4-PEPA | | | | |
| 1:0.925:0.15 | 1:0.925:0.15 | 1:0.8:0.4 | 1:0.85:0.3 | 1:0.95:0.1 |

Monomers

| | | | | | |
|---|---|---|---|---|---|
| 3,4′-ODA | 48.19 | 48.19 | 45.45 | 46.51 | 48.78 |
| 4,4′ ODPA | 44.58 | 44.58 | 36.36 | 39.53 | 46.34 |
| 4-PEPA | 7.23 | 7.23 | 18.18 | 13.95 | 4.88 |

| | |
|---|---|
| Extruder | Prism 16 millimeter Twin Screw Extruder (L/D: 40) |
| Order of addition | All ingredients were mixed by blender and then added at |
| | throat |

Temperature at different Zone, ° C.

| | | | | | |
|---|---|---|---|---|---|
| Zone 1 | 280 | 280 | 250 | 280 | 340 |
| Zone 2 | 280 | 280 | 270 | 280 | 340 |
| Zone 3 | 320 | 320 | 270 | 280 | 340 |
| Zone 4 | 320 | 320 | 270 | 280 | 340 |
| Zone 5 | 320 | 320 | 300 | 320 | 340 |
| Zone 6 | 320 | 340 | 300 | 320 | 340 |
| Zone 7 | 320 | 340 | 300 | 320 | 340 |
| Zone 8 (vacuum port) | 320 | 340 | 300 | 320 | 340 |
| Zone 9 | 320 | 340 | 300 | 320 | 340 |
| Die | 320 | 340 | 280 | 320 | 350 |
| Screw RPM | 250 | 250 | 200 | 200 | 250 |
| Results | Clear | Clear | Yellow | Yellow | Nice |
| | Brown | Brown | Opaque | Opaque | Ductile |
| | Molten | Molten | Strand | Strand | Clear |
| | Material | Material | | | Strand |
| Tg Of Uncured Resin | 212.8 | 214.7 | 180.9 | 195.6 | 223~224 |
| Measured By DSC, ° C. | | | | | |
| (Room Temp To 350° C.) | | | | | |
| Tg Of The Cured Resin | Not | Not | Not | Not | Not |
| By DSC (Room Temp To | Tested | Tested | Tested | Tested | Tested |
| 400° C.) | | | | | |
| Possibility To Make | Yes | Yes | Yes, | Yes | Yes |
| Spaghetti Form Which | | | barely | | |
| Can Support By Itself | | | | | |

TABLE 6

| Example | |
|---|---|
| 11 | 12 |
| Mole Ratio of Mole Ratio of | |
| 3,4′-ODA:4,4′-ODPA:PA | |
| 1:0.0.95:0.1 | 1:0.0.98:0.04 |

Monomers (Mole %)

| | | |
|---|---|---|
| 3,4′-ODA | 48.78 | 49.50 |
| 4,4′ ODPA | 46.34 | 48.51 |
| PA | 4.88 | 1.98 |

| | |
|---|---|
| Extruder | Prism 16 millimeter Twin Screw Extruder |
| | (L/D = 40) |
| Order of addition | All Ingredients Mixed via Blender and |
| | Added at Throat |

Temperature at different zones, ° C.

| | | |
|---|---|---|
| Zone 1 | 340 | 280 |
| Zone 2 | 340 | 370 |
| Zone 3 | 340 | 370 |
| Zone 4 | 360 | 370 |
| Zone 5 | 360 | 370 |
| Zone 6 | 360 | 370 |
| Zone 7 | 360 | 370 |
| Zone 8 (vacuum port) | 360 | 370 |
| Zone 9 | 360 | 380 |
| Die | 380 | 380 |
| Screw RPM | 250 | 150 |
| Observation at Die | Semi-Transparent | Yellow Opaque |
| | Brown Strand Came | Ductile Strand Came |
| | Out Of Die | Out Of Die |
| Tg Measured By DSC, ° C. | 217~223 | 234 |
| Tg Of Uncrosslinked | | |
| Aromatic Polyimide | | |
| Measured By DSC, (Room | | |
| Temp To 350° C.) | | |
| Filament Possibility | Yes | Yes |

Examples 1-10 demonstrated that a clear, ductile strand capable of being used as a 3D printing filament can be formed from the asymmetric 3,4′ ODA, the symmetric ODPA, and the 4-PEPA endcap in the molar ratio shown. It is significant to note that the molar ratio of 1:0.8:0.4 was the maximum amount of 4,4′-ODPA and 4-PEPA possible.

The IUPAC name for this new thermosettable aromatic polyimide of Examples 1-10 is: Poly (2-(4-{3-[1,3-dioxo-5-(2-phenylethynyl)-2,3-dihydro-1H-isoindol-2-yl]phenoxy}phenyl)-5-{[2-(3-{4-[1,3-dioxo-5-(2-phenylethynyl)-2,3-dihydro-1H-isoindol-2-yl]phenoxy}phenyl)-1,3-dioxo-2,3-dihydro-1H-isoindol-5-yl]oxy}-2,3-dihydro-1H-isoindole-1,3-dione).

Examples 11-12 also demonstrated that an acceptable, ductile strand capable of being used as a 3D printing filament can be formed from the asymmetric 3,4′ODA, the symmetric ODPA, and the PA endcap in the molar ratios shown.

The IUPAC name for the second new thermoplastic polyimide of Examples 11 and 12 is: Poly (2-{4-[3-(1,3-dioxo-2,3-dihydro-1H-isoindol-2-yl)phenoxy]phenyl}-5-[(2-{3-[4-(1,3-dioxo-2,3-dihydro-1H-isoindol-2-yl)phenoxy]phenyl}-1,3-dioxo-2,3-dihydro-1H-isoindol-5-yl)oxy]-2,3-dihydro-1H-isoindole-1,3-dione).

The formula for the new thermosettable polyimide of is:

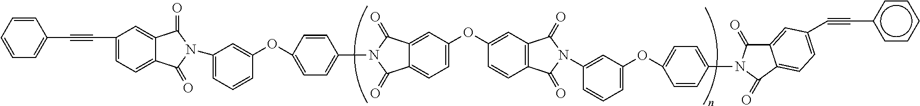

where n is a number from about 6 to about 50 and preferably from about 6 to about 20.

The formula for the new thermoplastic aromatic polyimide is:

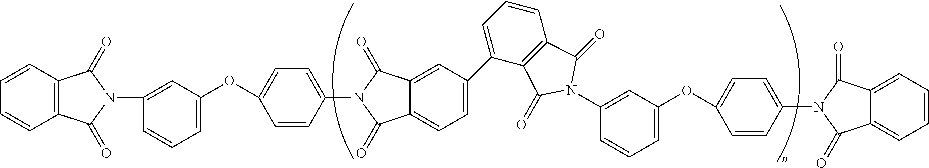

where n is a number greater than 20.

Separately, the thermosettable aromatic polyimide of the ingredients of Example 10 was replicated as Example 13 in a reactive extrusion using an 18 mm Leistritz Twin Screw Extruder (L/D: 60) using the reaction conditions of Table 7.

TABLE 7

Example
13
Mole ratio of
3,4′ODA:4,4′ODPA:4-PEPA
1:0.95:0.1

Monomers (Mole %)

| | |
|---|---|
| 3,4′-ODA | 48.78 |
| ODPA | 46.34 |
| 4-PEPA | 4.88 |
| Extruder | 18 mm Leistritz Twin Screw |
| | Extruder (L/D: 60) |
| Order of addition | All Ingredients Added At |
| | Throat |

Temperature at different zones, ° C.

| | |
|---|---|
| Zone 1 | 340 |
| Zone 2 | 340 |
| Zone 3 | 340 |
| Zone 4 | 340 |
| Zone 5 | 340 |
| Zone 6 | 340 |
| Zone 7 | 340 |
| Zone 8 (vacuum port) | 340 |
| Zone 9 | 340 |
| Die | 350 |
| Screw rpm | 250 |
| Observation at Die | Nice Ductile Clear Strand |
| Tg Measured By DSC, ° C. Tg Of | 224 |
| Uncrosslinked Aromatic | |
| Polyimide Measured By DSC, | |
| (Room Temp To 350° C.) | |
| Filament Possibility | Yes |

The aromatic polyimide of Example 13 was further tested by melt-mixing in the presence of carbon fiber at three weight percent levels: 1, 10, and 15 weight percent. The carbon fiber was “immediate modulus” in form and made by SGL of Strongsville, Ohio. USA. Each of those three experiments showed good dispersion of the carbon fiber in the aromatic polyimide, good adhesion of the carbon fiber to the aromatic polyimide, and no perceptible voids, which would otherwise make the filament deficient for 3D printing.

Each of the carbon-filled composites was then cured at 320° C. for 5 hours. It was noted that viscosity increased as carbon fiber loading increased except 1 wt. % carbon fiber filled composite.

There was no significant increase in viscosity after 2-hour testing. The gel time was greater than 120 minutes. However, for all the three carbon fiber filled composites, there was a faster increase in viscosity in the first 20 minutes which might be due to carbon fiber recovery from sample loading but not due to curing.

Another experiment determined that the thermosettable aromatic polyimide with functional endcap ready for crosslinking could be ground into a fine powder ranging from about 120 μm to about 670 μm. Powder is useful for selective laser sintering, showing the versatility of the aromatic polyimide to be further processed in a variety of ways.

The invention is not limited to above embodiments. The claims follow.

What is claimed is:

1. An aromatic polyimide comprising:
(a) Thermosettable Poly (2-(4-{3-[1,3-dioxo-5-(2-phenylethynyl)-2,3-dihydro-1H-isoindol-2-yl]phenoxy}phenyl)-5-{[2-(3-{4-[1,3-dioxo-5-(2-phenylethynyl)-2,3-dihydro-1H-isoindol-2-yl]phenoxy}phenyl)-1,3-dioxo-2,3-dihydro-1H-isoindol-5-yl]oxy}-2,3-dihydro-1H-isoindole-1,3-dione)
or
(b) Thermoplastic Poly (2-{4-[3-(1,3-dioxo-2,3-dihydro-1H-isoindol-2-yl)phenoxy]phenyl}-5-[(2-{3-[4-(1,3-dioxo-2,3-dihydro-1H-isoindol-2-yl)phenoxy]phenyl}-1,3-dioxo-2,3-dihydro-1H-isoindol-5-yl)oxy]-2,3-dihydro-1H-isoindole-1,3-dione).

2. An aromatic polyimide comprising the reaction product of
(1) 3, 4′-oxydianiline (3,4′ ODA);
(2) 4, 4′-Oxydiphthalic anhydride (4, 4′ ODPA); and
(3) an endcap selected from the group consisting of 4-phenylethynyl phthalic anhydride (4-PEPA) and phthalic anhydride (PA);
wherein the 3, 4′ ODA, the 4, 4′ ODPA, and the crosslinking agent are in a molar ratio of from about 1:0.80:0.4 to about 1:0.98:0.03, respectively.

3. The aromatic polyimide of claim 1, wherein the polyimide has a glass transition temperature ranging from about 170 to about 235° C.

4. The aromatic polyimide of claim 3, further comprising carbon fiber.

5. The aromatic polyimide of claim 4, wherein the filament has a diameter ranging from about 1.6 to about 2.1 mm.

6. The aromatic polyimide of claim 1, wherein aromatic polyimide is thermosettable and is the reaction product of
(1) 3, 4′-oxydianiline (3,4′ ODA);
(2) 4, 4′-Oxydiphthalic anhydride (4, 4′ ODPA); and
(3) 4-phenylethynyl phthalic anhydride (4-PEPA);
wherein the 3, 4′ ODA, the 4, 4′ ODPA, and 4-PEPA are in a molar ratio of from about 1:0.80:0.4 to about 1:0.98:0.03.

7. The aromatic polyimide of claim 4, wherein aromatic polyimide is thermosettable and is the reaction product of
(1) 3, 4′-oxydianiline (3,4′ ODA);
(2) 4, 4′-Oxydiphthalic anhydride (4, 4′ ODPA); and
(3) 4-phenylethynyl phthalic anhydride (4-PEPA);
wherein the 3, 4′ ODA, the 4, 4′ ODPA, and 4-PEPA are in a molar ratio of from about 1:0.90:0.2 to about 1:0.98:0.04.

8. The aromatic polyimide of claim 1, wherein aromatic polyimide is thermoplastic and is the reaction product
(1) 3, 4′-oxydianiline (3,4′ ODA);
(2) 4, 4′-Oxydiphthalic anhydride (4, 4′ ODPA); and
(3) phthalic anhydride (PA);
wherein the 3, 4′ ODA, the 4, 4′ ODPA, and PA are in a molar ratio of from about 1:0.95:0.1 to about 1:0.98:0.03, respectively.

9. The aromatic polyimide of claim 1, wherein the aromatic polyimide is prepared by solvent-less reactive extrusion.

10. The aromatic polyimide of claim 1, wherein the aromatic polyimide is in the form of a 3D printed article.

11. A composite comprising the aromatic polyimide of claim 1.

12. The composite of claim 11, wherein the composite includes carbon, glass, or synthetic fibers.

13. The composite of claim 11, in the form of a 3D printed article.

14. The composite of claim 11, wherein the aromatic polyimide is in the form of fine powder for selected laser sintering.

15. The aromatic polyimide of claim 7, wherein the thermosettable aromatic polyimide is cured to form a thermoset aromatic polyimide.

16. The aromatic polyimide of claim 2, wherein the aromatic polyimide is prepared by solvent-less reactive extrusion.

17. The aromatic polyimide of claim 2, wherein the aromatic polyimide is in the form of a 3D printed article.

18. A composite comprising the aromatic polyimide of claim 2.

19. The composite of claim 18, wherein the composite includes carbon, glass, or synthetic fibers.

20. The composite of claim 18, wherein the aromatic polyimide is in the form of a 3D printed article or in the form of fine powder for selected laser sintering.
